(19) United States
(12) Patent Application Publication
(10) Pub. No.: US 2005/0099654 A1
(43) Pub. Date: May 12, 2005

(54) Method for managing mail sender address of I-FAX

(76) Inventor: Ko-Meng Chen, Miao Li Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/006,576

(22) Filed: Dec. 8, 2004

Related U.S. Application Data
(63) Continuation-in-part of application No. 09/871,649, filed on Jun. 4, 2001, now abandoned.

(51) Int. Cl. G06F 15/00; H04N 1/00

(52) U.S. Cl. 358/1.15; 358/402

(57) ABSTRACT

A method for changing mail sender address of I-FAX is proposed. The mail sender address of I-FAX is changed by manually inputting a mail sender address or selecting a mail sender address from a built-in address book without changing the default setting. The mail recipient can identify different mail senders and correctly reply mail to true sender.

### CROSS-REFERENCE TO RELATED APPLICATIONS

This Application is a Continuation-in-Part of application Ser. No. 09/871,649, filed 4 Jun. 2001, and entitled METHOD FOR CHANGING MAIL SENDER ADDRESS OF I-FAX.

### FIELD OF THE INVENTION

The present invention relates to a method for managing mail sender address of I-FAX, especially to a method for manually changing mail sender address of I-FAX without changing the default setting.

### BACKGROUND OF THE INVENTION

The I-FAX (Internet-FAX) is an apparatus for transmitting facsimile data through e-mail for multiple users. The content of the e-mail includes e-mail address of mail receiver, e-mail address of mail sender and image file containing the facsimile data. In general, the e-mail address of mail sender from an I-FAX is a unique default e-mail address for multiple users.

FIG. 1 shows the flowchart of operational sequence of a prior art I-FAX.

(a) The e-mail address of mail receiver is input to the I-FAX.

(b) The program of the I-FAX is activated.

(c) The document for facsimile is scanned.

(d) The scanning task is finished.

(e) The I-FAX informs the default e-mail address thereof (such as ifax@mail.com.tw) to the mail server through the simple mail transfer protocol (SMTP).

(f) The mail server has corrective response.

(g) The I-FAX informs the e-mail address of mail receiver to the mail server.

(h) The mail server has corrective response.

(i) The I-FAX begins to transmit mail and the block of mail sender address in the mail is filled with ifax@mail.com.tw.

(j) The mail transmitting is finished.

Moreover, the scanning operations in steps (c) and (d) can also be performed before step (i).

However, the I-FAX always uses the default e-mail address thereof as the e-mail address of mail sender. The mail recipient can not identify the real mail sender.

In addition the address of sender is also required at the receiver side for mail response. If we wish to response the sender in a very short moment and not need to re-type the sender's mail address. We wish the new system can provide the function to auto-record the sender's mail address for mail response. Also we wish we can provide more application case on the portable electrical device.

### SUMMARY OF THE INVENTION

It is the object of the present invention to provide a method for changing mail sender address of I-FAX by inputting a mail sender address or selecting a mail sender address from a built-in address book without changing the default setting.

The other object of the present invention is to provide a series steps to record the sender's address in the receiver's side. Also we wish we can provide more application embodiment on the field of portable electrical device, such as PDA and notebook being used in the convenient store.

The various objects and advantages of the present invention will be more readily understood from the following detailed description when read in conjunction with the appended drawing, in which:

### BRIEF DESCRIPTION OF DRAWINGS

FIG. 1 shows the flowchart of operational sequence of a prior art I-FAX.

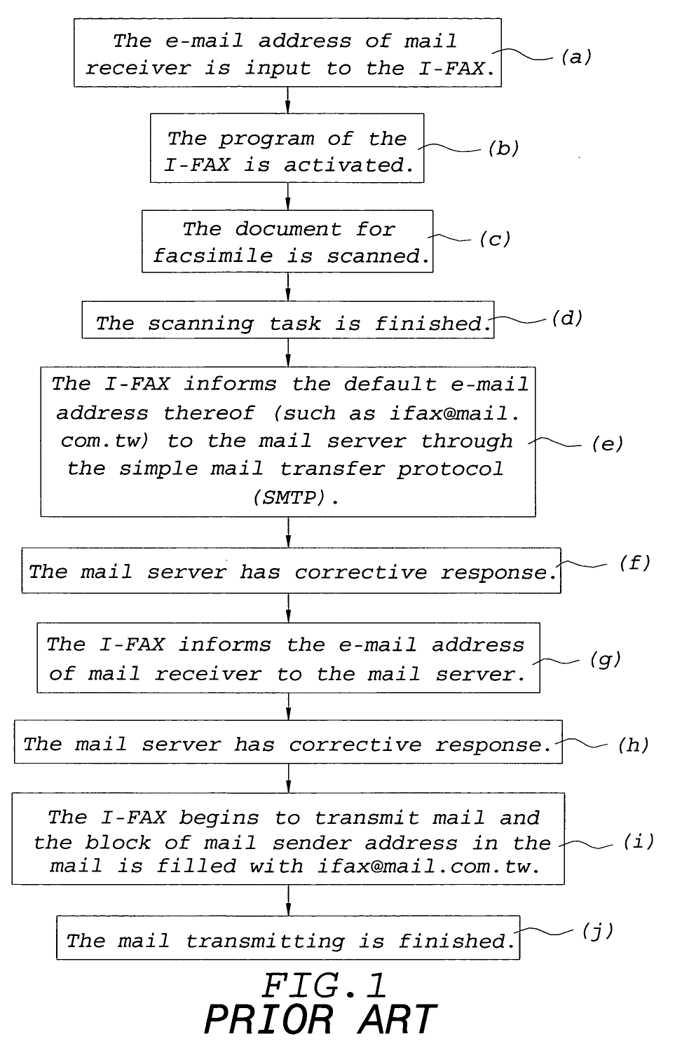

FIG. 2 shows the flowchart of operational sequence of method for changing mail sender address of I-FAX according to the present invention.

### DETAILED DESCRIPTION OF THE INVENTION

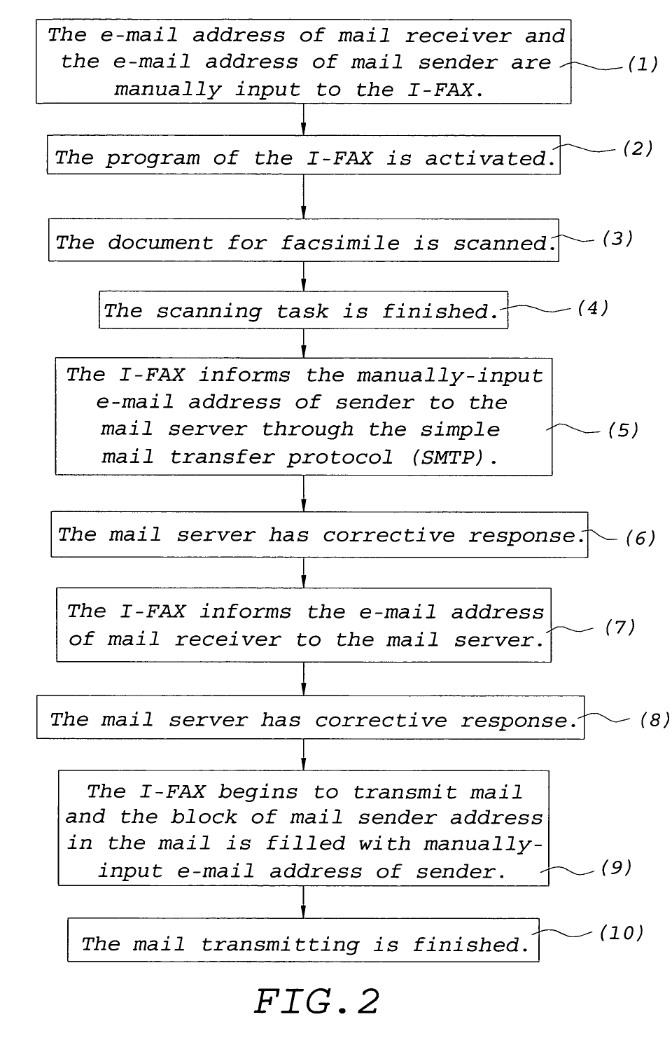

FIG. 2 shows the flowchart of operational sequence of method for changing mail sender address of I-FAX according to the present invention. The mail sender address of I-FAX is changed by inputting a mail sender address or selecting a mail sender address from a built-in address book without changing the default setting.

The method according to the present invention comprises following steps:
(1) The e-mail address of mail receiver and the e-mail address of mail sender are manually input to the I-FAX. The e-mail address of mail sender can be input by user pro se or by selecting an address from a built-in address book. If the e-mail address of mail sender is not manually input or selected, a default address is automatically used and fills the block of mail sender address in the e-mail.

(2) user being required if he want to register his email address to mail receiver;

(3) if user confirm the registering request, the sender mail will add check-string word to the sender's e-mail address; such as the “REV:alan chen”<alan @mail.com.tw>;

(4) The program of the I-FAX is activated.

(5) The document for facsimile is scanned.

(6) The scanning task is finished.

(7) The I-FAX informs the manually-input e-mail address of sender (for example alan@ mail.com.tw) or the default e-mail address thereof (such as ifax@mail.com.tw) to the mail server through the simple mail transfer protocol (SMTP).

(8) The mail server has corrective response.

(9) The I-FAX informs the e-mail address of mail receiver to the mail server.

(10) The mail server has corrective response.

(11) The I-FAX begins to transmit mail and the block of mail sender address in the mail is filled with alan@ mail.com.tw if an e-mail address for the user is manually input or selected, alternatively, the block is filled with default address if no e-mail address for the user is manually input.

(12) The mail transmitting is finished.

(13) the other machine of mail receiver receive the transmitted mail, and check the check-string word, then the machine will reserve the sender email to memory. (operation method is to check the check-string “REV”)

Moreover, the scanning operations in steps (5) and (6) can also be performed before step (11).

The address of sender is very required at the receiver side for mail response. We wish to response the sender in a very short moment and not need to re-type the sender's mail address. We design the above steps in the new system to provide the function to auto-record the sender's mail address for mail response.

In addition, the I-fax corresponding machines may have the function to transfer the image data from one site to another site; wherein the I-Fax corresponding machines at least comprising a portable electrical device, and the built-in address book being saved in the portable electrical device. (this embodiment can be applied in the area of note-book combine the internet coffee store or office machine in the convenient store) There are tow issues should be described: 1. some of the I-Fax systems do not need the scanner function can be just completed by the portable electrical device such as the PDA and the notebook from the wireless net. 2. The major issue is for the portable electrical device combined with the scanning machine (such as in the convenience store) needing the sender's address data saved in the portable device.

Also the various application embodiment can be shown in the below: 1. Wherein the check string word may comprise the sender's identification code or the user's identification code. 2. Further comprising a step (13) to respond a register finished message or failure message form receiver to sender, or further comprising a step (13) to respond a register finished message or failure message form receiver to a receiver's internet manager. 3. Further comprising a step (14) to respond a register finished message or failure message form sender to a sender's internet manager. 4. wherein the receiver's internet manager is installed on a computer PDA or the mobile phone. 5. wherein the sender's internet manager is installed on a computer, PDA or the mobile phone.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A method for managing mail sender address of an I-FAX, comprising following steps:
(1) the e-mail address of a mail receiver and the e-mail address of a mail sender are input to the I-FAX; the e-mail address of mail sender is manually input by a user or by selecting an address from a built-in address book;
(2) user being required if he want to register his email address to mail receiver;
(3) if user confirm the registering request, the sender mail will add check-string word to the sender's e-mail address;
(4) a program of the I-FAX is activated.
(5) a document for facsimile is scanned.
(6) the I-FAX informs the e-mail address of sender to a mail server through SMTP;
(7) the mail server has corrective response.
(8) the I-FAX informs the e-mail address of mail receiver to the mail server.
(9) the mail server has corrective response.
(10) the I-FAX begins to transmit mail and a block of mail sender address in the mail is filled with e-mail address of mail sender input in step (1);
(11) the mail transmitting is finished;
(12) the other machine of mail receiver receive the transmitted mail, and check the check-string word, then the machine will reserve the sender email to memory.

2. The method for managing mail sender address of an I-FAX as in claim 1, wherein if the e-mail address of mail sender is not manually input or selected in step (1), a default address is automatically used and fills the block of mail sender address in the e-mail.

3. The method for managing mail sender address of an I-FAX as in claim 1, wherein the scanning operations in step (5) can also be performed before step (10)

4. The method for managing mail sender address of an I-FAX as in claim 1, wherein the I-fax corresponding machines have the function to transfer the image data from one site to another site, wherein the I-Fax corresponding machines at least comprising a portable electrical device, and the built-in address book being saved in the portable electrical device.

5. The method for managing mail sender address of an I-FAX as in claim 1, wherein the check string word comprises the sender's identification code or the user's identification code.

6. The method for managing mail sender address of an I-FAX as in claim 1, further comprising a step (13) to respond a register finished message or failure message form receiver to sender.

7. The method for managing mail sender address of an I-FAX as in claim 1, further comprising a step (13) to respond a register finished message or failure message form receiver to a receiver's internet manager.

8. The method for managing mail sender address of an I-FAX as in claim 6, further comprising a step (14) to respond a register finished message or failure message form sender to a sender's internet manager.

9. The method for managing mail sender address of an I-FAX as in claim 7, wherein the receiver's internet manager is installed on a computer, PDA or the mobile phone.

10. The method for managing mail sender address of an I-FAX as in claim 8, wherein the sender's internet manager is installed on a computer, PDA or the mobile phone.
